(19) United States
(12) Patent Application Publication
(10) Pub. No.: US 2011/0273671 A1
(43) Pub. Date: Nov. 10, 2011

(54) Projector for Casting Light on the Ground beside a Vehicle

(75) Inventor: Min-Chieh Chu, Taichung (TW)

(73) Assignee: IDESIGN MAX CO., LTD., Taichung City (TW)

(21) Appl. No.: 12/775,476

(22) Filed: May 7, 2010

(51) Int. Cl. G03B 21/14

(52) U.S. Cl. 353/13

(57) ABSTRACT

A projector includes a projection unit located in a shell provided on a vehicle. The projection unit includes a light, a screen, a convex-convex lens and a plane-convex lens. The screen is located in front of the light. The convex-convex lens is located in front of and separated from the screen. The plane-convex lens is located in front of and separated from the convex-convex lens. The light casts light onto the ground in an area beside the vehicle through the screen so that a sign is shown on the ground.

### BACKGROUND OF INVENTION

1. Field of Invention

The present invention relates to a projector for use in a vehicle and, more particularly, to a projector for projecting a sign on the ground in an area beside a vehicle while lighting up the area.

2. Related Prior Art

Lights are used in vehicles for illumination. Headlights are turned on for lighting up an area in front of a vehicle in bad weather and at night. A ceiling light is turned on for lighting up the interior of a vehicle.

A vehicle has however never been equipped with a projector to light up an area beside it to enable a driver or passenger to clearly observe the area before he or she steps outside the vehicle. The driver or passenger might step into a water or mud and get dirty. The driver of passenger might step into a pothole or stumble on a rock or any other obstacle and get hurt.

The present invention is therefore intended to obviate or at least alleviate the problems encountered in prior art.

### SUMMARY OF INVENTION

It is the primary objective of the present invention to provide a vehicle with a projector for projecting a sign on the ground in an area beside the vehicle while lighting up the area.

To achieve the foregoing objective, the projector includes a projection unit located in a shell provided on a vehicle. The projection unit includes a light, a screen, a convex-convex lens and a plane-convex lens. The screen is located in front of the light. The convex-convex lens is located in front of and separated from the screen. The plane-convex lens is located in front of and separated from the convex-convex lens.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a vehicle equipped with a projector for projecting a sign on the ground in an area beside the vehicle while lighting up the area according to the preferred embodiment of the present invention;

FIG. 2 is a perspective view of the projector shown in FIG. 1;

FIG. 3 is an exploded view of the projector shown in FIG. 2;

FIG. 4 is a cross-sectional view of the projector shown in FIG. 2; and

FIG. 5 is a perspective view of the projector located in another position of the vehicle than shown in FIG. 1.

### DETAILED DESCRIPTION OF PREFERRED EMBODIMENT

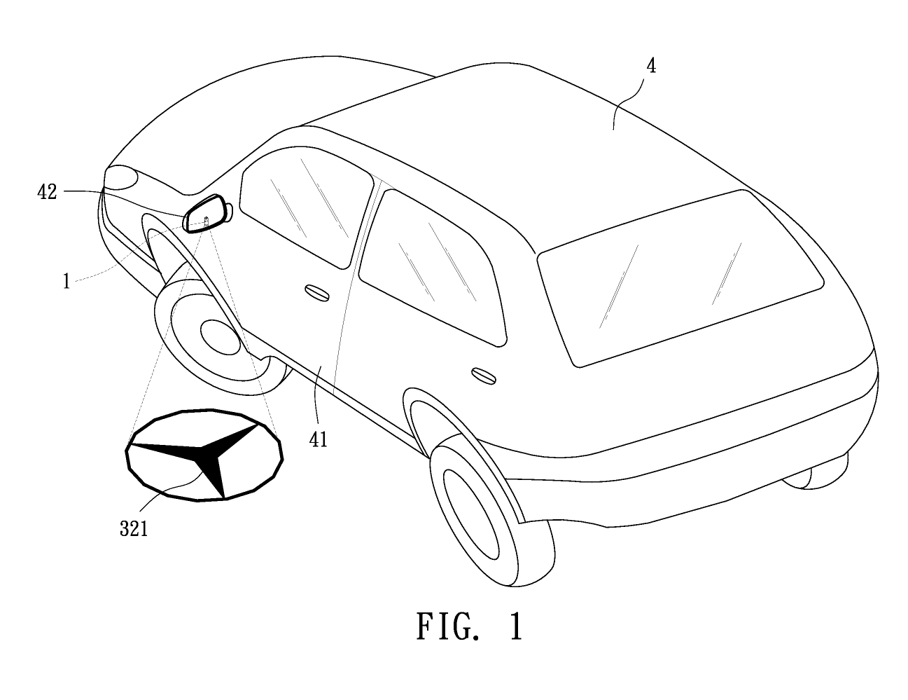

Referring to FIG. 1, a vehicle 4 is equipped with a projector according to the preferred embodiment of the present invention. The projector is provided on a side-view mirror of the vehicle 4. The projector can be used to light up a side of the vehicle 4 so that a driver can watch clearly before he or she steps outside the vehicle 4.

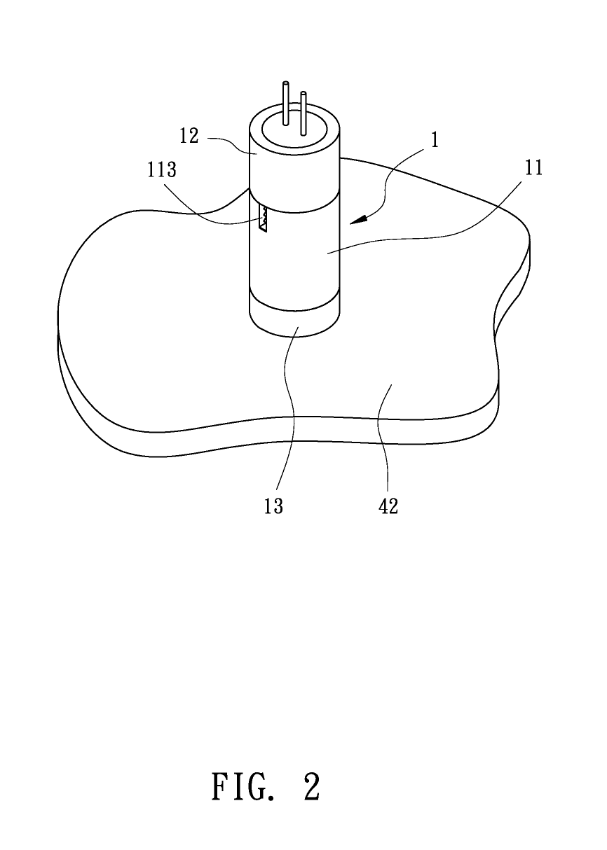

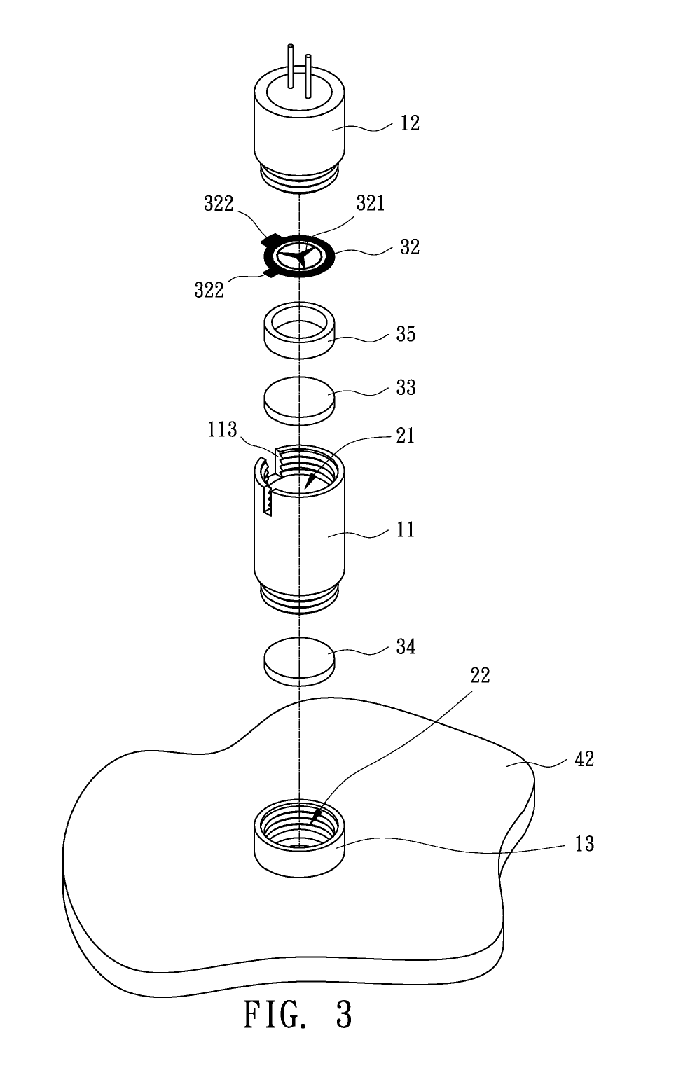

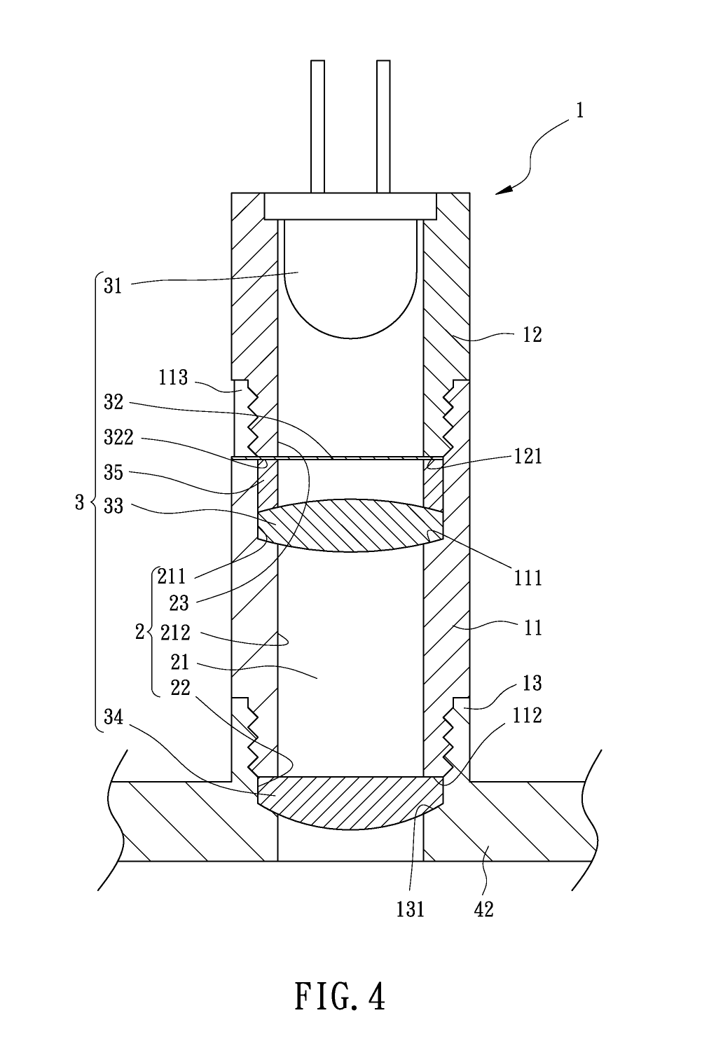

Referring to FIGS. 2 to 4, the projector includes a shell 1 and a projection unit 3. The shell 1 includes a barrel 11, a socket 12 and a frame 13. The barrel 11 includes two opposite ends 111 and 112. The barrel 11 includes a space 21 axially extending from the end 111 to the end 112. Furthermore, the barrel 11 includes two cutouts 113 defined in an annular edge formed at the end 111. The space 21 includes a first section 211 and a second section 212 with a diameter smaller than that of the first section 211.

The shell socket 12 includes a space 23 defined therein. The space 23 extends throughout the shell socket 12.

The frame 13 includes a cavity 22 defined therein. The cavity 22 extends throughout the frame 13. The frame 13 includes an annular shoulder 131 formed on an internal side thereof. The frame 13 is formed on or attached to a frame of a side-view mirror 42 of the vehicle 4. The spaces 21 and 23 and the cavity 22 together become a chamber 2 in the shell 1.

The projection unit 3 includes a light 31, a screen 32, a convex-convex lens 33, a plane-convex lens 34 and a spacer 35. The light 31 is preferably a light-emitting diode.

The screen 32 includes a pattern 321 printed or formed thereon and two tabs 322 extending from an edge thereof. The pattern 321 can be designed according to a logo of the manufacturer of the vehicle 4.

The light 31 is located in the socket 12. The light 31 is energized by a power supply such as a battery used in the vehicle 4. Preferably, the light 31 is electrically connected to a microcomputer used in the vehicle 4. Thus, the light 31 is under the control of the microcomputer. The convex-convex lens 33, the spacer 35 and the screen 32 are located between an annular shoulder formed between the sections 211 and 212 of the space 21 and an end 121 of the socket 12. The end 121 of the socket 12 is inserted in and connected to the barrel 11. The tabs 322 are located in the cutouts 113 so that the screen 32 is positioned relative to the barrel 11. The spacer 35 is preferably a ring located between the screen 32 and the convex-convex lens 33. The plane-convex lens 34 is located in the cavity 22. An annular area of a convex face of the plane-convex lens 34 is located against the annular shoulder 131 of the frame 13.

The spacer 35 separates the screen 32 from the convex-convex lens 33. The length of the spacer 35 is determined by a desired distance of the screen 32 from the convex-convex lens 33. The length or depth of the second section 212 of the space 21 is determined by a desired distance of the convex-convex lens 33 from the plane-convex lens 34.

Referring to FIG. 1, the projector is located on a side-view mirror 42. The projector is turned on to project a sign on the ground in an area beside the vehicle 4 and light up the area, with the door closed. The sign is determined by the pattern 321. Hence, a driver can observe the area clearly before he or she steps outside the vehicle 4.

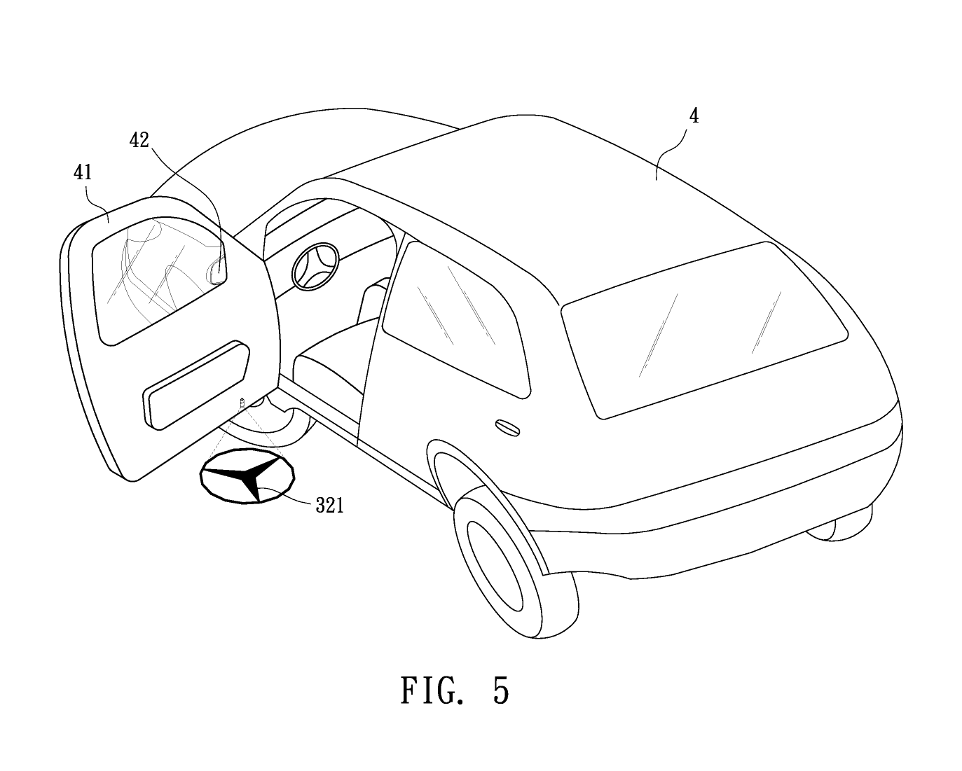

Referring to FIG. 5, the projector is located on an internal side of a door 41 of the vehicle 4 instead of the side-view mirror 42. Thus, the projector is turned on to project a sign on the ground in an area beside the vehicle 4 and light up the area, with the door 41 opened. Hence, a driver can observe the area clearly before he or she steps outside the vehicle 4.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A projector including:
a shell provided on a vehicle; and
a projection unit including a light located in the shell, a screen located in front of the light, a convex-convex lens located in front of and separated from the screen, a plane-convex lens located in front of and separated from the convex-convex lens, wherein the light casts light onto the ground in an area beside the vehicle through the screen so that a sign is shown on the ground.

2. The projector according to claim 1, wherein the projection unit includes a spacer located between the screen and the convex-convex lens.

3. The projector according to claim 2, wherein the spacer is a ring.

4. The projector according to claim 1, wherein the shell 1 includes:
a socket for receiving the light;
a barrel for receiving the screen and the convex-convex lens, wherein the barrel is connected to the socket;
a frame for receiving the plane-convex lens, wherein the frame is connected to the barrel and connected to the vehicle.

5. The projector according to claim 4, wherein the barrel includes a space extending from an end to an opposite end, wherein the space includes a first section and a second section, wherein the diameter of the first section is larger than that of the second section, wherein the socket includes a space in communication with the first section of the space of the barrel, wherein the frame includes a cavity in communication with the second section of the space of the barrel.

6. The projector according to claim 5, wherein the projection unit includes a spacer located between the screen and the convex-convex lens.

7. The projector according to claim 6, wherein the screen, the spacer and the convex-convex lens are located between an end of the socket and an internal portion of the barrel.

8. The projector according to claim 6, wherein the plane-convex lens is located between an end of the barrel and an internal portion of the frame.

9. The projector according to claim 4, wherein the socket includes at least one cutout defined in an end, wherein the screen includes at least one tab located in the cutout.

10. The projector according to claim 1, wherein the shell is attached to a side-view mirror of the vehicle.

11. The projector according to claim 1, wherein the shell is attached to an internal side of a door of the vehicle.
